(19) United States
(12) Patent Application Publication
(10) Pub. No.: US 2024/0102322 A1
(43) Pub. Date: Mar. 28, 2024

(54) Anti-Theft Guard Assembly For Outdoor Cell Site Cabinets

(71) Applicant: James Edwin Curry, Glendale, CA (US)

(72) Inventor: James Edwin Curry, Glendale, CA (US)

(21) Appl. No.: 18/372,650

(22) Filed: Sep. 25, 2023

Related U.S. Application Data
(60) Provisional application No. 63/410,572, filed on Sep. 27, 2022.

(51) Int. Cl. E05B 67/38; E05B 13/00

(52) U.S. Cl. CPC E05B 67/383; E05B 13/002

(57) ABSTRACT

The present invention is a unique anti-theft guard assembly for outdoor cell site cabinets that have right or left pivoting door handles that are easily broken into by vandals. The guard assembly is removably attached to the door of the cabinet with a puck lock or padlock, and prevents access to the door handles and mounting footprints of the assembly to the door.

### FIELD OF THE INVENTION

This invention relates in general providing anti-theft protection to the doors of outdoor cell site cabinets. In particular this invention relates to providing an anti-theft guard assembly for the door handles of the Ericsson E6160 and B6160 cabinets.

### BACKGROUND OF THE INVENTION

In the last three decades the number of cell sites has grown substantially. Each carrier competes to grow the largest network, but also to be the first in integrating the newest technologies into their network. In short, the cell sites are constantly being upgraded.

Quite a substantial number of cell sites are located outside, giving rise to a large number of outdoor cell site cabinets designed specifically for the needs of the industry. These sites are prone to being vandalized, thieves ripping out anything of salvage value. Some of the old cabinets had door latch mechanisms that were very difficult, if not impossible, to be vandalized. But these old cabinets are being phased out and replaced with new cabinets integrating new technologies. Unfortunately, the designs of some of these new cabinets completely overlook the problem of vandalization.

Take for example the Ericsson E6160 and B6160 cabinets currently being deployed. The B6160 door is hinged of the right and E6160 door is hinged on the left. The door latch mechanisms for each cabinet are mirror images of each other, and they both can easily be defeated by a vandal. The cheap key and handle of these cabinets can be broken into in a manner of seconds. In fact, both cabinets are often broken into, and the batteries in the B6160 cabinets are constantly harvested by vandals for salvage, leaving the site without battery backup.

The existing door latch handle of these cabinets are known to be inadequate, quickly and easily defeated by vandals. In addition, the sheet metal of the doors are incredibly thin (0.062 inch thick) and are not well suited for welding or being attached with an anchor bolt, or the like. Further, there is a limited two-inch strip of the door where the handle is located in which to try to attach something, and on the inside of the door in this strip area resides the latch mechanism rods going to the top and bottom of the door. In short, there is little room to work with to attach a anti-theft bracket to prevent vandals from opening these doors.

Hence, there is a need to provide a solution to the vandal problem with these cabinets, a solution that prevents quick/easy access for vandals while dealing with the limitations of these cabinets mentioned above.

### BRIEF SUMMARY OF THE INVENTION

The present invention introduces novel solution to the vandalization problem for outdoor cell site cabinets that are not well designed to prevent vandalization. The present invention anti-theft guard assembly, when installed on the door, prevents access to the door latch handle, and thereby prevents opening the door. The door cannot be opened until the guard assembly is removed from the door. The guard assembly is secured with a lock, and is easily removed from the door by one having the key or combination of the lock, which is preferably a puck lock.

The present invention provides its benefits across a broad spectrum of outdoor cell site cabinets not well designed to prevent vandalization. The present invention is discussed in conjunction with the Ericsson E6160 and B6160 outdoor cell site cabinets, but is not exclusive to them. What is taught herein can be adapted to other outdoor cell site cabinets having a similar door latch configuration that is not well designed to prevent vandalization.

It is one aspect of the present invention to provide an anti-theft guard assembly that prevents access to the door latch handle when installed to the door.

It is another aspect of the present invention to provide an anti-theft guard assembly that, when installed to the door, prevents the opening of the door.

It is yet another aspect of the present invention to provide an anti-theft guard assembly that is installed with a lock that and is easily removed and installed only by those having the key or combination to the lock.

It is a feature of the present invention that backing plates establish two mounting footprints to attach to the thin metal of the door.

It is another feature of the present invention that the guard bracket is flush with all edges of the door, preventing vandals from seeing, or having access to, the mounting footprints of the assembly to the door.

It is another feature of the present invention that a lock shield is provided of sufficient thickness to deter vandals from cutting or grinding to remove the lock.

It is still another feature of the present invention that all parts of the guard bracket exposed to the outside are of sufficient thickness to deter vandals from cutting or grinding to remove the bracket.

It is an advantage of the present invention that its installation does not interfere with the existing door latch mechanism of the cabinet.

It is another advantage of the present invention that a vandal cannot see how the assembly is attached to the door, making it unobvious as to how to remove it from the door.

These and other aspects, features, and advantages are achieved/attained in the apparatus of the present invention anti-theft guard assembly comprising T-shaped mounting bracket having a base portion and a latch portion 16, the latch portion having a hole for receiving the locking pin of a puck lock. The base portion having mounting holes for attaching the mounting bracket to the door of a cabinet. The guard assembly further comprises a catch bracket having a bottom portion and upwardly bent tab portion, the bottom portion having mounting holes for attaching the catch bracket to the door, the bent tab portion having a cut-out portion on the side facing the hinged side of the door. The guard assembly further comprises two backing plates having mounting holes, the mounting bracket being attached to the door with one backing plate and the catch bracket being attached to the door with the other backing plate, establishing two mounting footprints for the thin metal of the door.

The guard assembly further comprises a removable elongated guard bracket having a front face, a left side, a bottom shield, a top shield, and a lock shield. The front face having an opening for receiving the latch portion of the mounting bracket. The lock shield is preferably configured for use with a puck lock, the shield being affixed to the front face and left side and positioned to allow installation of the locking pin of the puck lock thru the hole of the mounting bracket.

The guard assembly further comprises a mating catch piece having a downwardly bent tab portion and a block portion. The catch piece and catch bracket interact to allow for pivotal motion to install and reinstall the guard bracket, making the guard bracket is completely removable from the door, but when installed on the door making mounting footprints unviewable by a potential vandal.

### BRIEF DESCRIPTION OF THE DRAWINGS

The aspects, features and advantages of the present invention will become apparent upon consideration of the following detailed disclosure of the invention, especially when it is taken in conjunction with the accompanying drawings wherein:

FIG. 1 is an exploded isometric view of an embodiment of the anti-theft guard assembly of the present invention for a right hinged cabinet door.

FIG. 2 is an isometric view of the elongated guard bracket and catch piece of the embodiment in FIG. 1.

FIG. 3 is an isometric view showing the interaction of the catch bracket and catch piece of the embodiment in FIG. 1.

FIG. 4 is an isometric view showing the location of the catch piece and guard bracket prior to attachment of the embodiment in FIG. 1.

FIG. 5 is an exploded isometric view of the mounting bracket, catch bracket, and backing plates, as they are attached to the door of the cabinet, of the embodiment in FIG. 1.

FIG. 6 is an isometric view showing how the guard assembly is attached and removed to the door of the cabinet, of the embodiment of FIG. 1.

FIG. 7 is an isometric view showing how the guard assembly is positioned in place for final attachment by the puck lock of the embodiment of FIG. 1.

FIG. 8 is an isometric view showing how the guard assembly is finally attached to the door of the cabinet of the embodiment of FIG. 1.

FIG. 9 is an isometric view of an alternate embodiment of the lock shield for use with a padlock.

FIG. 10 is an exploded isometric view of an embodiment of the anti-theft guard assembly of the present invention for a left hinged cabinet door.

FIG. 11 is an isometric view showing how the guard assembly is finally attached to the door of the cabinet of the embodiment of FIG. 10.

To facilitate understanding, identical reference numerals have been used, where possible, to designate identical elements or features common to the figures.

### DETAILED DESCRIPTION OF THE PREFERRED EMBODIMENTS

In order to provide a solution to the vandal problem mentioned above, a few concepts as to anti-theft design should be mentioned. Foremost, an anti-theft design for outdoor cell site cabinet must be intimidating to break into by a potential thief. It must appear to take a long time to break into, make a lot of noise to do so, and appear unobvious how to do so. Meeting these goals is what deters a thief breaking into an outdoor cell site cabinet.

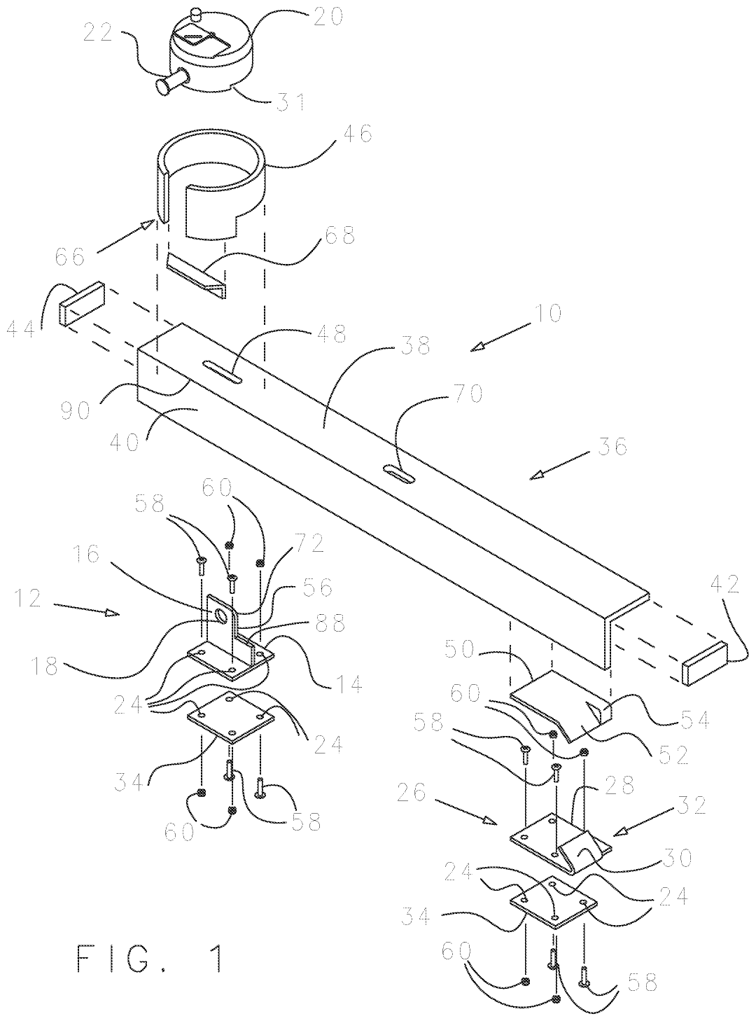

Referring now to FIGS. 1-8, an anti-theft guard assembly 10 is shown for an outdoor cabinet 11 having a right hinged door 13 and left pivoting handle 15. In this preferred embodiment, the outdoor cabinet 11 is an Ericsson B6160 cabinet that is installed at numerous cell sites in the United States and is used as a battery backup cabinet. The cabinet door is formed from sheet steel approximately 0.062 inches thick and has an out facing panel 17 establishing a narrow strip 19 of about two inches in which the pivoting handle 15 resides.

The guard assembly 10 comprises a T-shaped mounting bracket 12 having a base portion 14 and latch portion 16, the latch portion having a hole 18 for receiving the locking pin 22 of a puck lock 20, the base portion 14 having mounting holes 24 for attaching the mounting bracket 12 to the door 13 of the cabinet. The guard assembly 10 further comprises a catch bracket 26 having a bottom portion 28 and upwardly bent tab portion 30, the bottom portion having mounting holes 24 for attaching the catch bracket to the door, the bent tab portion having a cut-out portion 32 on the side facing the hinged side of the door 13. The guard assembly 10 further comprises two backing plates 34 having mounting holes 24, the mounting bracket 12 being attached to the door with one backing plate and the catch bracket 26 being attached to the door with the other backing plate.

The guard assembly 10 further comprises a removable elongated guard bracket 36 that, when installed, blocks access to the left pivoting handle 15, which secures the cabinets from thieves trying to break in. The elongated guard bracket 36 has a front face 38, a left side 40, a bottom shield 42, a top shield 44, and a lock shield 46. In this embodiment the lock shield 46 is configured to receive a puck lock 20. The front face 38 has an opening 48 for receiving the latch portion 16 of the mounting bracket 12. The lock shield 46 being affixed to the front face 38 and left side 40 and positioned to allow installation of the locking pin 22 of the puck lock 20 thru the hole 18 of the mounting bracket 12. It is also positioned so that the offset step 31 of the puck lock 20 will rest on the edge of the guard bracket, shown by numeral 90, and extend sufficiently below the bottom of the puck lock 20 to allow attachment of the angle piece 66.

The guard assembly 10 further comprises a mating catch piece 50 having a downwardly bent tab portion 52 and a block portion 54 facing the hinged side of the door 13 when affixed to the guard bracket 36. The catch piece 50 ultimately is part of the guard bracket 36 but must be appropriately located in conjunction with the mounting positions of the mounting bracket 12 and catch bracket 26.

Referring particularly to FIG. 3, the catch piece 50 is shown with the catch bracket 26 to illustrate how the two interact to prevent movement of the guard assembly 10 when installed on the door. The downwardly bent tab portion 52 of the catch piece 50 engages the upwardly bent tab portion 30 of the catch bracket 26 when installed on the door. When installed, the opening 48 of the guard bracket 36 is nearly flush with edge 56 of the mounting bracket 12, preventing the guard bracket 36 from moving up, and the interaction of the catch piece 50 and catch bracket 26 prevents forward movement of the guard assembly 10 when installed on the door. Also seen in FIG. 3 is the block portion 54 of the catch piece 50 engaging the cut-out portion 32 of the catch bracket 26, which prevents left side movement of the guard assembly when installed on the door. This configuration, along with the left side 40 of the guard bracket 36 extending 90 degrees over the left edge of the door prevents removal prevents right side movement of the guard assembly 10, and with the puck lock 20 installed the guard assembly is secured to the door.

It is to be appreciated that the interaction of the catch piece 50 and catch bracket 26 allow for pivotal motion to install and reinstall the guard bracket 36 without the use of a conventional hinge. Because of this, the guard bracket is completely removable from the door, and the mounting points established by the catch piece 50 and catch bracket 26 are hidden inside the guard and are unviewable and inaccessible. To the potential vandal trying to break in, this makes it unobvious how to break in, and serves to deter a thief.

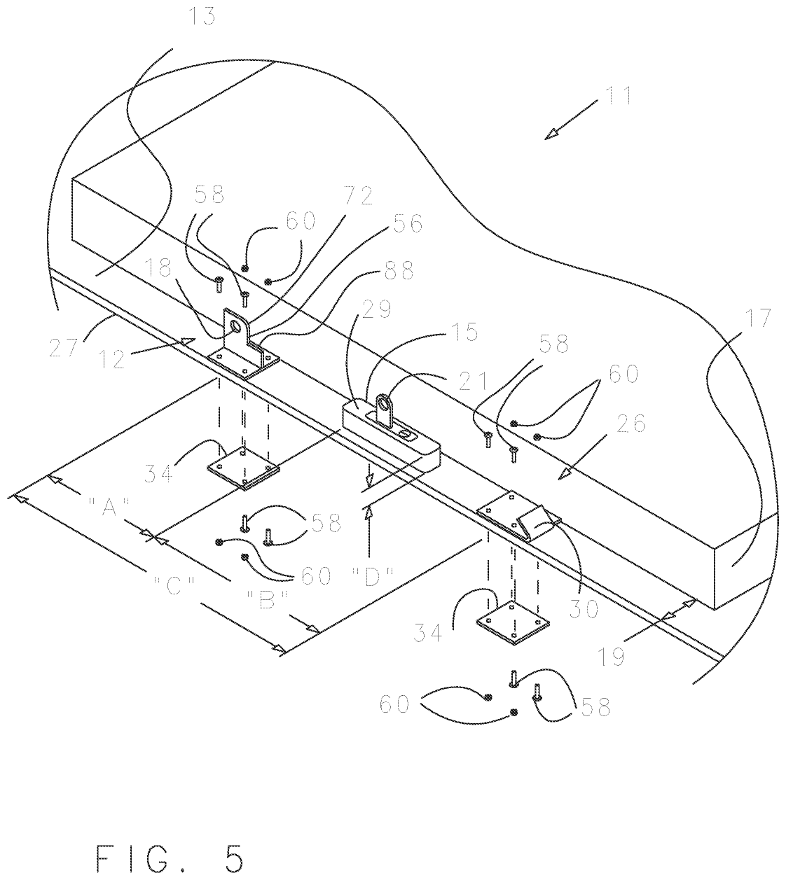

It is preferred that the mounting holes 24 of the mounting bracket 12, catch bracket 26 and backing plates 34 follow a common mounting hole pattern, and are mounted to the door of the cabinet with fasteners. Preferably the hole pattern is sized to avoid interfering with the opening action of the opening handle 15. With the Ericson B6160 (and E6160) cabinet, the narrow strip 19 available for attachment to the door is two inches. In this embodiment the backing plates are two inches square with a square mounting hole pattern. The backing plates are made from ⅛-inch steel with a centered square mounting hole pattern of 1.375 inches with a hole size of about 0.200 inches diameter to receive 10 #-24×0.75″ button head screws (identified by numeral 58) with 10 #-24 nylon nuts (identified by numeral 60). It should be noted that the screws nearest the hinge portion of the door are installed from inside the door, as seen in FIGS. 1 and 5. This is to prevent damage to the elastomeric seal of the door inside of the cabinet. Alternatively, rivets could be used instead of screws, if desired.

It may appear that mounting the guard assembly 10 with small 10 #-24 screws would be inadequate to preventing a vandal from removing the assembly, as most puck lock hasps are installed with anchor bolts of ½ inch diameter. Although it would be quick and easy for a vandal to cut or grind out these sized screws, they are unable to do so because they are unviewable and inaccessible. It is to be appreciated that the two backing plates 34 and their common mounting hole pattern establish two mounting footprints surrounding the thin metal of the door when attached to the mounting bracket 12 and catch bracket with a combined thickness a little greater than ¼ inch thick. These two mounting footprints and their mounting fasteners, invisible and inaccessible to the vandal, are sufficiently separated from each other to dissipate evenly any load about the thin metal of the door by a vandal trying to pry the guard assembly open. This sufficient distance provides structural stability of the assembly to the door and allows for the use of uncommonly small fasteners. Referring to FIG. 5, dimension “C” the centerline distance between the mounting footprints is preferably between about 13 and 15 inches apart, with the mounting footprint being two inches square.

It is preferred to make a mounting template to locate the exact position on the door 13 where to drill the mounting holes for attaching the mounting bracket, catch bracket, and backing plates. Referring to FIG. 5, dimension “A” and “B” are necessary to locate these positions. For the Ericson B6160 (and E6160) cabinet, when “A” is 4.625 inches and “B” is 9.6875 inches, satisfactory results are achieved with the mounting hole pattern above to avoid the internal mechanisms of the door latch mechanism. Dimension “C” turns out to be 14.5 inches

With the exact positions of the attachment of the mounting bracket and catch bracket determined, the proper position of the catch piece 50 to the guard bracket 36 can be determined. Referring to FIG. 4, the catch piece 50 is shown on the back side of the front face 38 in its proper position prior to attachment. The block portion 50 can be seen formed by a bent tab 62 and triangle piece 64 that are welded in place. The catch piece 50 is preferably welded in place along all possible edges. It should also be noted that a gap of about ¾ of an inch be between the end of the catch piece 50 and bottom shield 42. This assists in the removal of the guard assembly 10 and also makes it difficult for a thief to see in or pry on the catch piece 50.

Referring to FIG. 5, dimension “D” represents the height of the handle 15 from the surface of the door. It is preferred that the height of the bottom shield 42, top shield 44, and ledge 88 of the mounting bracket 12, be the same height “D” of the handle. Additionally, the height “E” between the catch bracket 26 and catch piece 50, shown in FIG. 3, should be the same height “D” of the handle. This assures a snug and secured mounting position of guard bracket on all contact surfaces of the door and handle surface 29 when the puck lock is installed, making it difficult for a vandal to pry under the guard assembly. For the B6160 (and B6160) cabinets, this height “D” of the handle is 0.75 inches.

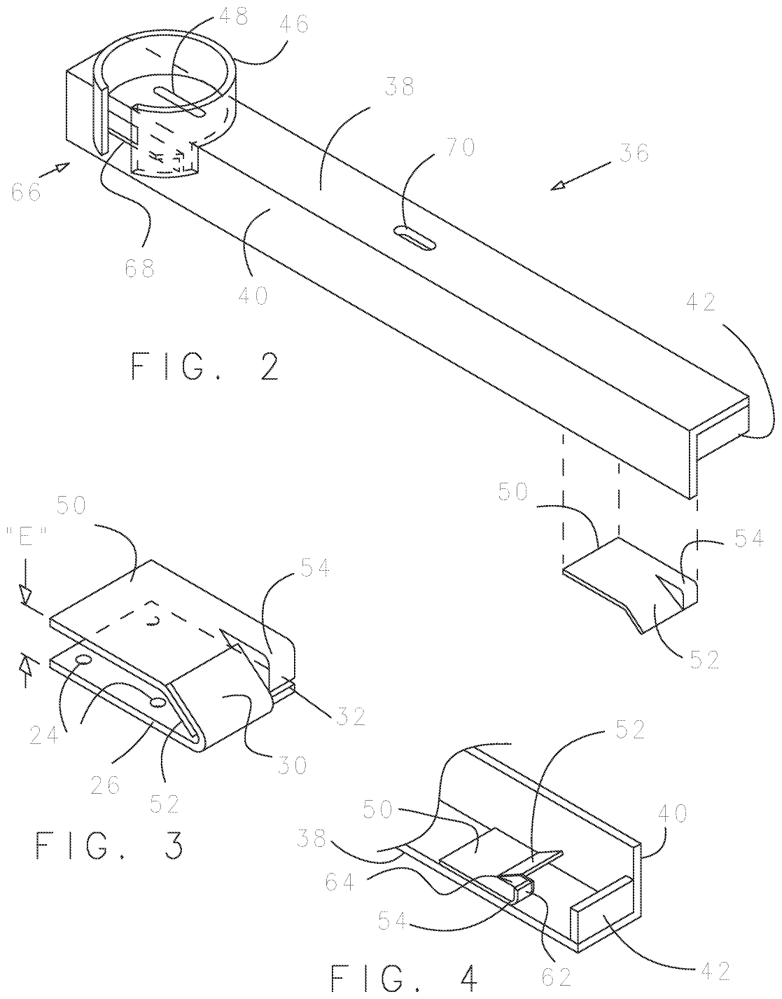

Referring to FIG. 2, the removable elongated guard bracket 36 is shown. The lock shield 46 is preferably welded continuously along its contact with the front face 38 and the left side 40 of the guard bracket 36 so as to discourage any thief from trying to cut thru it. The lock shield has a continuous opening 66 to accommodate the retraction of the puck lock locking pin 22 during removal and installation. The opening 66 is continuous so as not to provide a base to allow a potential vandal to use to pry on the puck lock 20. It has been found that making the lock shield 46 from schedule 40 black pipe at 3″ diameter provides satisfactory results as being thick and robust enough to discourage potential thieves from attempting to break through the shield to get to the puck lock. Also seen in FIGS. 1 and 2 is a small angle piece 68 preferably welded inside the lock shield 46. This piece, not visible to a vandal, prevents potential thieves from hammering or prying on the backside of the puck lock.

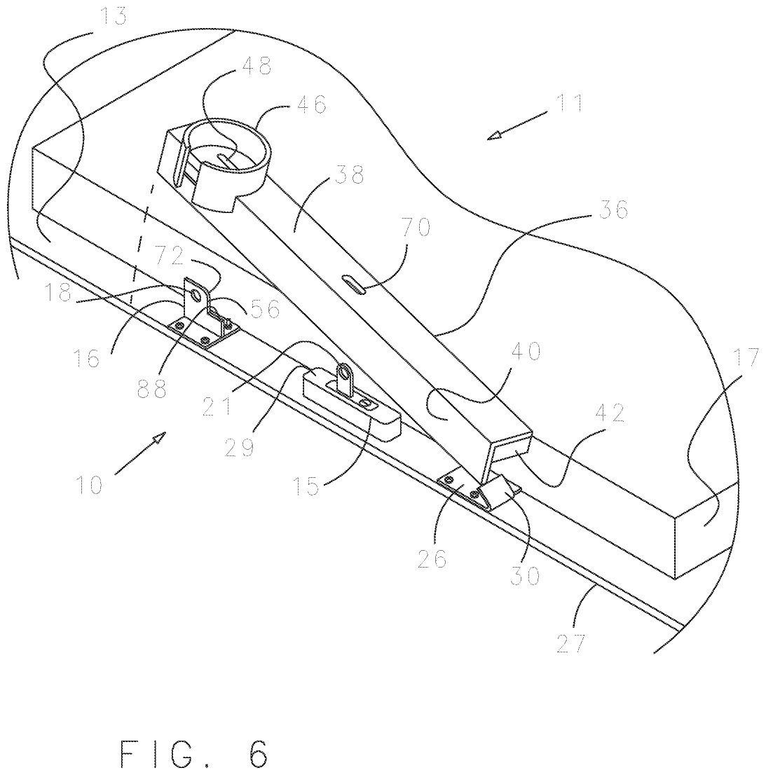

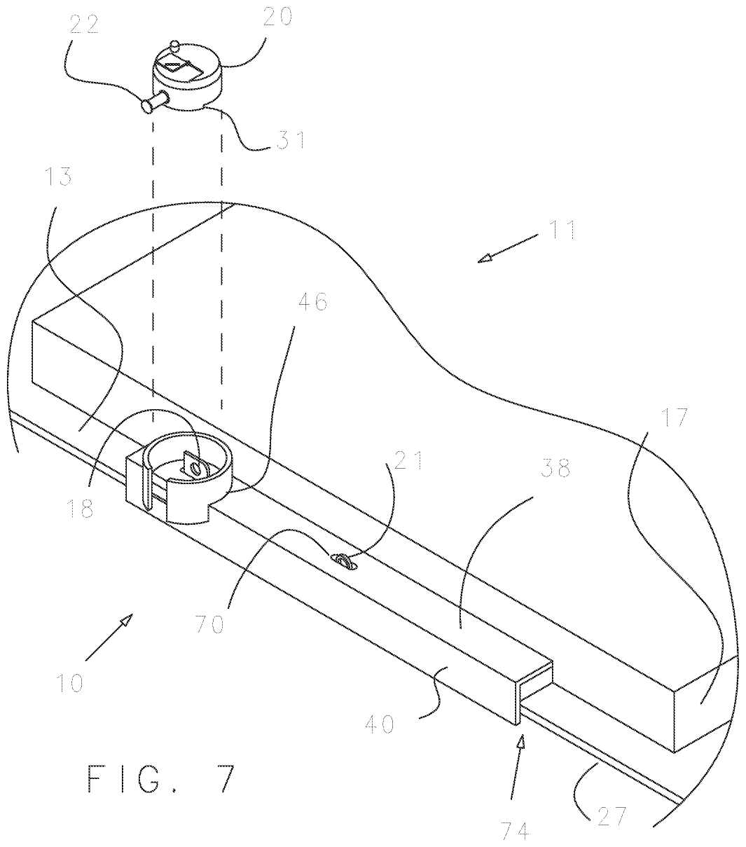

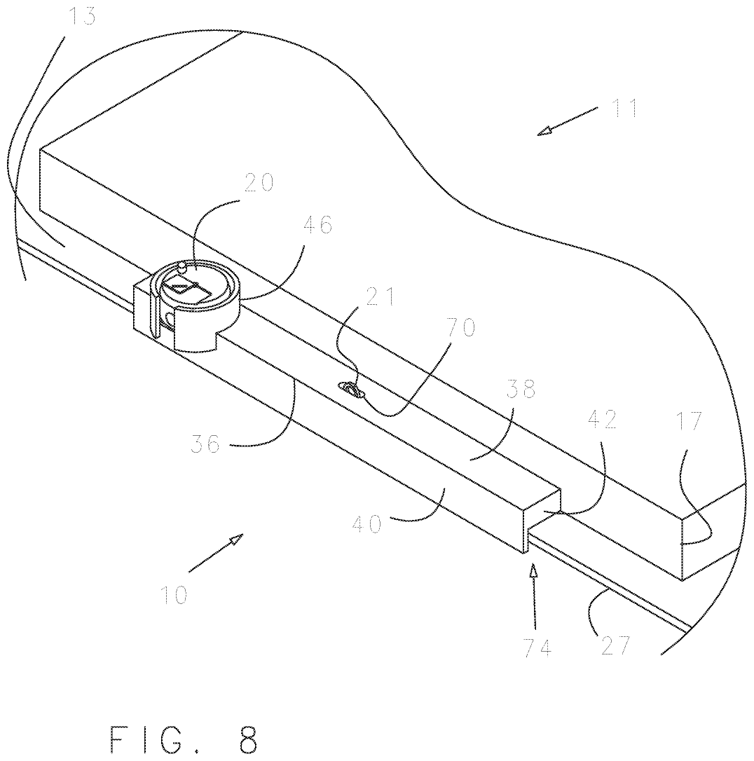

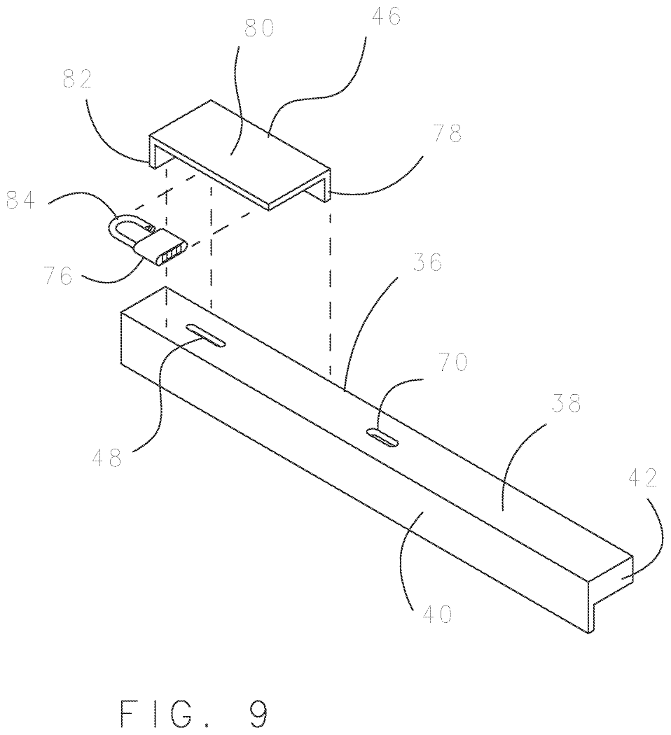

Referring to FIGS. 6-8, it is shown how the anti-theft guard assembly 10 is easily installed and removed from the cabinet. FIG. 6 shows how the guard bracket 36 is positioned to allow downward insertion for the catch piece 50 to engage the catch bracket 26 for installation. Once the catch piece 50 and catch bracket 26 engage, the guard bracket is rotated vertically as shown in FIG. 7. The puck lock 20 is the brought into position and the locking pin 22 engages hole 18 of mounting bracket 12, as shown in FIG. 8. It should be noted that slot 70 is provided to allow anchor hole 21 of the opening handle 15 to extend outward through the guard bracket 36 as needed for clearance. Also, a rounded corner 72 is provided in the latch portion 16 to assist in removal and installation of the guard bracket 36.

Ideally the edge of front face 38 is in contact with the out facing panel 17, the edges of the bottom shield 42 and top shield 44 are in contact with the out facing panel 17 and door 13, the inside of the front face 38 is in contact with handle surface 29 and ledge 88 of the mounting bracket, and the opening 48 of front face 38 is in contact with edge 56 of the latch portion 16 when the puck lock 20 is installed. This provides a completely secure mount of the guard assembly 10 to the door in all directions that a vandal would try to pry to remove.

In the embodiment shown, the mounting bracket 12, catch bracket 26, backing plates 34, and catch piece 50 are formed from ⅛-inch-thick steel, providing more than ¼ inch thickness of material when attached to the door. Because these parts are not accessible or visible to the potential thief, and because the sheet metal of the door is so thin, that with the backing plates and mounting footprint and fasteners installed it has proven to provide sufficient strength and stability to the guard assembly 10. Although the mounting bracket 12 and catch bracket 26 can be thicker than ⅛-inch if desired, it is preferred not to make the backing plates any thicker as they will start to interfere with the door latch mechanisms inside the door. The elongated guard bracket 36 is exposed and accessible to a potential thief and must be substantially thicker steel. It needs to be at least around ¼ inch thick or thicker, including its bottom shield 42 and top shield 44, to make cutting or grinding of the bracket 36 very time consuming and noisy for a potential thief. This is similar to the thickness of the schedule 40 pipe used in the lock shield 46 and it should be noted that it takes about 40 minutes to cut thru this pipe held in a vice with a reciprocating saw. It is important that all welds for the bottom shield 42, top shield 44, and catch piece 50 be made from the inside of the bracket 36 so they are inaccessible to the potential thief. It is these thicknesses, and lack of exposure as to how or where the guard assembly 10 is attached to the door 13, that deters thieves from attempting to break into the cabinet. Further deterrence is the thickness of the lock shield 46 and its continuous weld to the guard bracket 36 which would take considerable time to defeat by grinding or cutting. This makes the guard assembly appear to take too long a time to break into and too noisy to do so.

It should also be noted that left side 40 of the guard bracket 36 extends beyond the end of the door, as shown by numeral 74 in FIGS. 7 and 8, to prevent any prying in the door gap. The end of the door is identified by numeral 27. In the embodiment shown, the front face 38 and left side 40 are formed from an L-shaped steel that is ¼ inch thick, or greater, with the front face 38 being about 2 inches wide and the left side 40 being about 2.25 inches wide. The lock shield 46, formed from a 2-inch length of 3-inch diameter schedule 40 black pipe, with a 0.75-inch cutout going 2.20 inches in from the edge of the pipe so that the shield 46 overlaps the front face 38 and left side 40 of the guard bracket 36. Angle piece 60 is a ½×½×1.25 standard L-shape steel piece. The opening 48 of the guard bracket 36 is a slot at 1.626 inches long with a diameter of 9/32 and is centered on the front face 38. Slot 70 is at 1.250 inches with a diameter of 0.375 and is centered on the front face 38. The guard bracket is 21 inches overall in length. The latch portion 16 of the mounting bracket 12 is welded to the base portion 14 at a position to accommodate receiving the puck lock 20 as its step 31 abuts the edge 90 of the front face 38 and left side 40 of the guard bracket 36. This location is not centered on the base portion 14, hence making the mounting bracket 12 specific to either a right or left hinged door. The upwardly bent tab portion 30 of the catch bracket 26 is bent to about 40 degrees between it and the bottom portion 28. The cut-out portion 32 is about 0.625 inches into the tab portion 30. Similarly, downwardly bent tab portion 52 of the catch piece 50 is bent at about 40 degrees, and the block portion 54 is about 0.625 inches wide so as to interact with the cut-out portion 32 of the catch bracket 26.

The embodiment shown in FIGS. 1-8 is an anti-theft guard assembly 10 configured for use with a puck lock 20, the lock shield 46 shaped to surround the puck lock. Although a puck lock is preferred, the anti-theft guard assembly 10 can also be configured for use with a convention padlock, if desired. Referring to FIG. 9, the guard bracket 36 is shown for use with a conventional padlock 76. The lock shield 46 in this embodiment comprises guard plates 78, 80, and 82 having the same thickness of the guard bracket (¼ inch) and are welded to the front face 38 of the guard bracket 36. These guard plates are configured to prevent access to the padlock as possible, while allowing access to remove and install the padlock by combination or key. The lock shield in this configuration prevents cutting or grinding off the arm 84 of the padlock, however the arm 84 of the lock 76 is partially exposed to the vandal. Because of this exposure, the puck lock configuration is preferred.

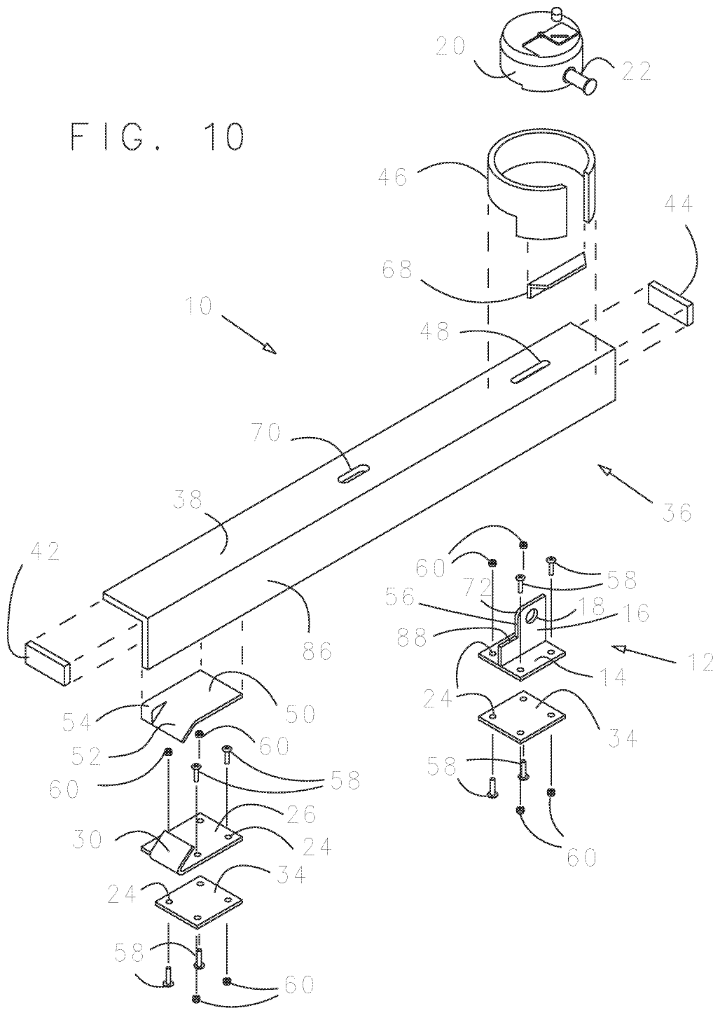

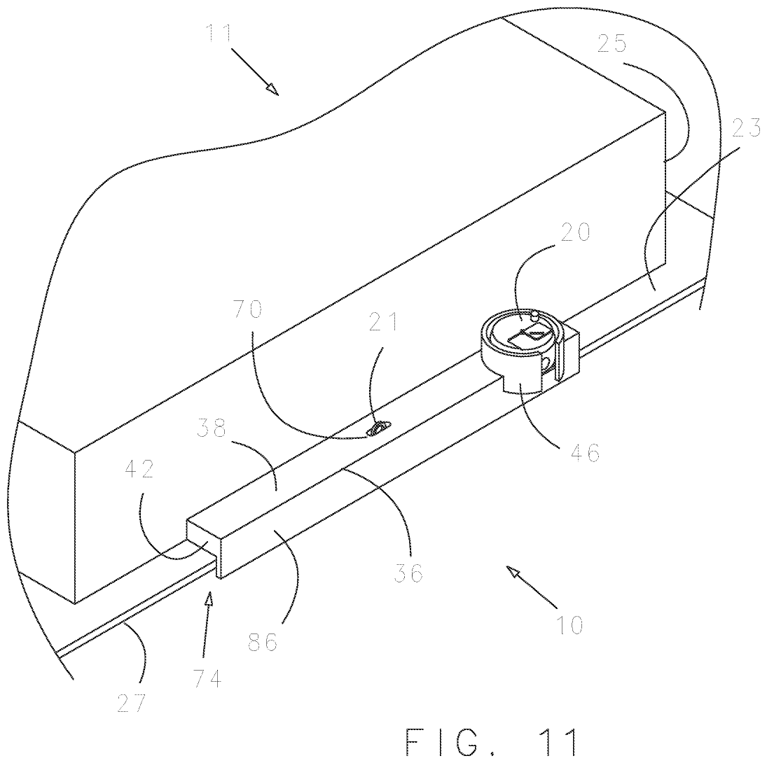

Shown in FIGS. 10 and 11 is an alternate embodiment of the present invention anti-theft guard assembly 10 for an outdoor cabinet 11 having a left hinged door 23 and right pivoting handle. In this embodiment, the outdoor cabinet 11 is an Ericsson E6160 cabinet. This cabinet houses critical equipment for the functioning of the cell site, and its door is essentially the mechanical mirror image of the door of the B6160 cabinet, but with its out facing panel 25 protruding substantially further. In this embodiment, the anti-theft guard assembly is the mirror image of the embodiment shown in FIGS. 1-8. The elongated guard bracket has a right side 86 instead of a left side 40 and is the mirror image of the guard bracket in the embodiment of FIGS. 1-8. In addition, the catch bracket 26, catch piece 50, and mounting bracket 12 are also the mirror images of those shown in the embodiments of FIGS. 1-8.

In all the embodiments the guard assembly is fabricated from steel, and is preferably treated to prevent oxidation. The assembly can be painted, anodized, or plated, as desired, to provide protection from oxidation.

What has been described are preferred embodiments of an anti-theft guard assembly for outdoor cell site cabinets not well designed to prevent vandalization. Those skilled in the art will appreciate that numerous modifications are possible without materially departing from the novel teachings and advantages of the subject matter described herein. Other modifications, substitutions, changes, and omissions may be made in the design and arrangement of the preferred and other exemplary embodiments without departing from the spirit of the present invention.

What is claimed is:

1. A anti-theft guard assembly for a outdoor cabinet installed at cell sites, the cabinet having a right hinged door and left pivoting opening handle, the guard assembly comprising:
a mounting bracket having a base portion and a latch portion, the latch portion having a hole for receiving a lock, the base portion having mounting holes for attaching the mounting bracket to the door of the cabinet;
a catch bracket having a bottom portion and upwardly bent tab portion, the bottom portion having mounting holes for attaching the catch bracket to the door of the cabinet, the bent tab portion having a cut-out portion on the side facing the hinged side of the door;
two backing plates, each plate having mounting holes, the mounting bracket attached to the door with one backing plate and the catch bracket attached to the door with the other backing plate;
a removable elongated guard bracket, the guard bracket having a front face, a left side, a bottom shield, a top shield, and a lock shield, the front face having an opening for receiving the latch portion of the mounting bracket, the lock shield affixed to the front face and left side and positioned to allow installation of the lock thru the hole of the mounting bracket, the top shield and the bottom shield being affixed to ends of the front face and the left side respectively to prevent access to the inside of the guard bracket once installed on the door;
a mating catch piece having a downwardly bent tab portion and a block portion facing the hinged side of the door when affixed to the guard bracket, the downwardly bent tab portion and the upwardly bent tab portion interacting to prevent forward movement of the guard assembly when installed on the door, and the block portion engaging the cut-out portion of the catch bracket preventing left side movement of the guard assembly when installed on the door; and,
the mounting holes of the mounting bracket, catch bracket, and backing plates follow a mounting hole pattern, the mounting bracket attached with the one backing plate to the door with fasteners, the catch bracket attached with the other backing plate to the door with fasteners, and wherein the mounting hole patterns and fasteners are invisible and inaccessible to a potential vandal when the guard assembly is installed on the door.

2. A anti-theft guard assembly of claim 1 wherein the outdoor cabinet is an Ericsson B6160 cabinet.

3. A anti-theft guard assembly of claim 1 wherein the lock shield is configured for use with a puck lock, the lock shield having an opening for the locking pin of the puck lock to open and close.

4. A anti-theft guard assembly of claim 1 wherein the lock shield is configured for use with a padlock, the lock shield comprising guard plates attached to the face of the guard bracket.

5. A anti-theft guard assembly of claim 1 wherein the mounting hole pattern establishes two mounting footprints to the door sufficiently separated from each other to provide structural stability of the assembly to the door.

6. A anti-theft guard assembly of claim 5 wherein the mounting footprints are two inches square and the distance between the footprints is between 13 and 15 inches.

7. A anti-theft guard assembly for a outdoor cabinet installed at cell sites, the cabinet having a left hinged door and right pivoting opening handle, the guard assembly comprising:
a mounting bracket having a base portion and a latch portion, the latch portion having a hole for receiving a lock, the base portion having mounting holes for attaching the mounting bracket to the door of the cabinet;
a catch bracket having a bottom portion and upwardly bent tab portion, the bottom portion having mounting holes for attaching the catch bracket to the door of the cabinet, the bent tab portion having a cut-out portion on the side facing the hinged side of the door;
two backing plates, each plate having mounting holes, the mounting bracket attached to the door with one backing plate and the catch bracket attached to the door with the other backing plate;
a removable elongated guard bracket, the guard bracket having a front face, a right side, a bottom shield, a top shield, and a lock shield, the front face having an opening for receiving the latch portion of the mounting bracket, the lock shield affixed to the front face and left side and positioned to allow installation of the lock thru the hole of the mounting bracket, the top shield and the bottom shield being affixed to ends of the front face and the left side respectively to prevent access to the inside of the guard bracket once installed on the door;
a mating catch piece having a downwardly bent tab portion and a block portion facing the hinged side of the door when affixed to the guard bracket, the downwardly bent tab portion and the upwardly bent tab portion interacting to prevent forward movement of the guard assembly when installed on the door, and the block portion engaging the cut-out portion of the catch bracket preventing right side movement of the guard assembly when installed on the door; and,
the mounting holes of the mounting bracket, catch bracket, and backing plates follow a mounting hole pattern, the mounting bracket attached with the one backing plate to the door with fasteners, the catch bracket attached with the other backing plate to the door with fasteners, and wherein the mounting hole patterns and fasteners are invisible and inaccessible to a potential vandal when the guard assembly is installed on the door.

8. A anti-theft guard assembly of claim 7 wherein the outdoor cabinet is an Ericsson E6160 cabinet.

9. A anti-theft guard assembly of claim 7 wherein the lock shield is configured for use with a puck lock, the lock shield having an opening for the locking pin of the puck lock to open and close.

10. A anti-theft guard assembly of claim 7 wherein the lock shield is configured for use with a padlock, the lock shield comprising guard plates welded to the face of the guard bracket.

11. A anti-theft guard assembly of claim 7 wherein the mounting hole pattern establishes two mounting footprints to the door sufficiently separated from each other to provide structural stability of the assembly to the door.

12. A anti-theft guard assembly of claim 11 wherein the mounting footprints are two inches square and the distance between the footprints is between 13 and 15 inches.
